(19) United States
(12) Patent Application Publication
(10) Pub. No.: US 2008/0246428 A1
(43) Pub. Date: Oct. 9, 2008

(54) Industrial Robot

(76) Inventor: Toshiaki Shimada, Hiroshima (JP)

Correspondence Address: Studebaker & Brackett PC, 1890 Preston White Drive, Suite 105, Reston, VA, 20191, US

(21) Appl. No.: 10/581,720

(22) PCT Filed: Sep. 20, 2005
(86) PCT No.: PCT/JP2005/017307

§ 371 Date: Jun. 5, 2006

(51) Int. Cl. B25J 9/00

(52) U.S. Cl. 318/568.11; 901/19

(57) ABSTRACT

A robot arm 3 includes a base-side arm component 11, an intermediate arm component 12, and a tip-side arm component 13. The intermediate arm component 12 is divided at an axially intermediate position into a base-side part 20 and a tip-side part 21, which are connected so as not to be separated from each other in the arm axis direction but rotatable around the arm axis. The base-side part 20 fixedly contains a moving device 31 for axially moving a drive shaft. The tip-side part 21 fixedly contains a threaded member 32 meshed with a thread groove formed in the outer surface of the drive shaft. The drive shaft is axially moved while being meshed with the threaded member 32 so that the threaded member 32 rotates around the drive shaft. As a result, the tip-side part 21 rotates in the arm axis direction.

### TECHNICAL FIELD

The present invention relates to an articulated industrial robot and specifically falls within a technical field relating to a structure that improves the flexibility in movement of a robot arm.

### BACKGROUND ART

Conventionally, for example, in assemblage factories, cargo handling fields, etc., a workpiece which exists at a certain place is carried to a destination by an industrial robot. A well-known example of such an industrial robot used for carrying a workpiece is an articulated industrial robot having a robot arm which is formed by connecting a plurality of arm components as disclosed in Patent Document 1. Among the plurality of arm components of this industrial robot, a base-side arm component provided on the base side is swingably connected to a base by a connection shaft which extends generally horizontally. A tip-side arm component provided on the tip side is swingably connected to the tip-side end of the base-side arm component by a connection shaft which extends generally horizontally. The tip-side end of the tip-side arm component is provided with a wrist for grasping a workpiece. The tip-side arm component and the base-side arm component are swung around the connection shafts by actuators to move the wrist, whereby the workpiece is carried to a destination.
[Patent Document 1] Japanese Patent Publication for Opposition No. 7-115312

### DISCLOSURE OF INVENTION

### Problems to be Solved by the Invention

In the assemblage factories and cargo handling fields, obstructing articles are sometimes distributed around a place where a workpiece to be transferred exists and a destination to which the workpiece is to be transferred. In the case where the industrial robot of Patent Document 1 is used in such a work field, it is difficult to move the robot arm in such a manner that arm components and a workpiece are not interfered with by the articles around a place where the workpiece exists and a destination to which the workpiece is to be transferred. This is because this industrial robot has low flexibility in movement of the robot arm such that the arm components only swing around connection shafts.

The above problem can be dismissed by removing the surrounding articles or moving the robot arm itself to a different place such that the arm components and the workpiece are not interfered with by the surrounding articles. However, this solution is sometimes difficult to apply because of the space of the work field, the locations of the place where the workpiece exists and the destination to which the workpiece is to be transferred.

The present invention was conceived in view of the above circumstances. An objective of the present invention is to improve the flexibility in movement of a robot arm to smoothly transfer a workpiece without removing articles around the place where the workpiece exists and the destination to which the workpiece is to be transferred or moving the robot arm itself to a different place such that arm components and the workpiece are not interfered with by the surrounding articles.

### Means for Solving the Problems

To achieve the above objective, according to the present invention, an arm component of a robot arm which is closer to a base than a tip-side arm component of the robot arm is divided at an axially intermediate position into a base-side part and a tip-side part, and the tip-side part is rotated around the arm axis relative to the base-side part.

Specifically, the first invention is directed to an articulated industrial robot, comprising: a robot arm including a plurality of arm components swingably connected to one another by connection shafts; and a base to which the robot arm is connected, wherein the robot arm includes arm actuation means for swinging the arm components, the arm components includes a first arm component at a tip side of the robot arm, the first arm component having a wrist at its tip-side end, and the arm components includes a second arm component which is closer to the base than the first arm component is, the second arm component being divided at an axially intermediate position into a base-side part and a tip-side part, and the second arm component having rotation means for rotating the tip-side part around the arm axis relative to the base-side part.

With the above structure, when the tip-side part of the second arm component is rotated by the rotation means around the arm axis, the first arm component provided on the tip side of the robot arm rotates in the same direction. Since the first arm component is actuated by the arm actuator to swing, the swing direction of the first arm component can be changed according to the rotation angle of the tip-side part. Thus, the flexibility in movement of the robot arm is improved.

According to the second invention, in the first invention, the rotation means includes a drive shaft extending in the arm axis direction and having a thread groove in its outer surface, a moving device for axially moving the drive shaft, and a threaded member meshed with the thread groove of the drive shaft; and the moving device is fixed to one of the base-side part and the tip-side part, while the threaded member is fixed to the other.

With the above structure, for example, in the case where the moving device is fixed to the base-side part and the threaded member is fixed to the tip-side part, axial movement of the drive shaft by the moving device causes the threaded member to rotate along the thread groove of the drive shaft. Accordingly, the tip-side part rotates around the arm axis. Alternatively, in the case where the moving device is fixed to the tip-side part and the threaded member is fixed to the base-side part, axial movement of the drive shaft by the moving device causes the drive shaft and the moving device to rotate relative to the threaded member of the base-side part. Accordingly, the tip-side part rotates around the arm axis.

According to the third invention, in the second invention, the base-side part and the tip-side part are hollow; and the moving device is contained in one of the base-side part and the tip-side part, while the threaded member is contained in the other.

With the above structure, the rotation means can be contained inside the second arm component.

According to the fourth invention, in the second or third invention, the moving device includes a nut meshed with the thread groove of the drive shaft, a motor for rotating the nut around the drive shaft, and a speed reduction mechanism for reducing a rotation speed of the output shaft of the motor to transmit a torque of the motor to the nut.

With the above structure, when the nut is rotated by the motor, the drive shaft axially travels. Since at this step the rotation speed of the output shaft of the motor is reduced so that the torque of the nut is increased, a large thrust of the drive shaft can be secured even when a low-power, light-weight motor is used, and accordingly, the tip-side part can be rotated around the arm axis with sufficient force.

According to the fifth invention, in one of the first to fourth inventions, the first arm component includes wrist actuation means for reciprocating the wrist in the arm axis direction.

With the above structure, for example, when the process of transferring a workpiece is accompanied by the necessity of moving the workpiece in the arm axis direction, the workpiece can be moved in the arm axis direction only by reciprocating the wrist using the wrist actuator without swinging any arm component.

### Effects of the Invention

According to the first invention, the second arm component is divided into the base-side part and the tip-side part, and the tip-side part is rotatable relative to the base-side part. Therefore, the swing direction of the first arm component provided on the tip side of the robot arm can be changed, and thus, the flexibility in movement of the robot arm can be improved. With such a feature, the robot arm can be moved such that arm components and a workpiece are not interfered with by the surrounding articles without removing articles around the place where the workpiece exists and the destination to which the workpiece is to be transferred or moving the robot arm itself to a different place. As a result, the robot arm can smoothly transfer the workpiece.

According to the second invention, the tip-side part can be rotated around the arm axis only by linearly moving the drive shaft.

According to the third invention, the rotation means can be contained in the second arm component. Therefore, the robot arm having the rotation means can be compactly constructed.

According to the fourth invention, the tip-side part of the second arm component can be rotated with sufficient force using a low-power, light-weight motor. Therefore, the robot arm having the rotation means can be a light-weight robot arm.

According to the fifth invention, only the wrist can be reciprocated in the arm axis direction without swinging any arm component. Therefore, the flexibility in movement of the robot arm can be further improved. Further, when the wrist is moved in the arm axis direction, it is only necessary to control the wrist actuator without swinging any arm component. Thus, the control of the robot arm can be simplified.

### BRIEF DESCRIPTION OF DRAWINGS

FIG. 1 is a side view of an industrial robot according to an embodiment.

FIG. 2 is an enlarged back view of the industrial robot which shows the base side of a base-side arm component and elements therearound.

FIG. 3 is a cross-sectional view taken along line A-A of FIG. 1.

FIG. 4 is a cross-sectional view taken along line B-B of FIG. 3.

FIG. 5 is a block diagram of the industrial robot.

FIG. 6 is a schematic illustration of the industrial robot.

FIG. 7 is an illustration corresponding to FIG. 1 in which the tip-side part of an intermediate arm component is rotated around the arm axis.

FIG. 8 is a back view of the industrial robot in which the tip-side part of the intermediate arm component is rotated around the arm axis.

FIG. 9 is an illustration corresponding to FIG. 3 in which a connector is provided between the base-side part and tip-side part of the intermediate arm component.

FIG. 10 is a cross-sectional view taken along line C-C of FIG. 9.

### DESCRIPTION OF REFERENCE NUMERALS

1 Industrial robot

2 Base

3 Robot arm

11 Base-side arm component

12 Intermediate arm component (Second arm component)

13 Tip-side arm component (First arm component)

14 Wrist

20 Base-side part

21 Tip-side part

22 Arm rotator (Rotation means)

30 Drive shaft

30a Thread groove

31 Moving device

32 Threaded member

33 Motor

34 Speed reduction mechanism

35 Nut

37 Output shaft

61 Base-side arm actuator (Arm actuation means)

62 Intermediate arm actuator (Arm actuation means)

63 Tip-side arm actuator (Arm actuation means)

78 Wrist actuator (Wrist actuation means)

### BEST MODE FOR CARRYING OUT THE INVENTION

Hereinafter, an embodiment of the present invention is described with reference to the drawings. It should be noted that the following descriptions of the preferred embodiment are merely exemplary in essential and do not intend to limit the present invention, applications thereof, or uses thereof.

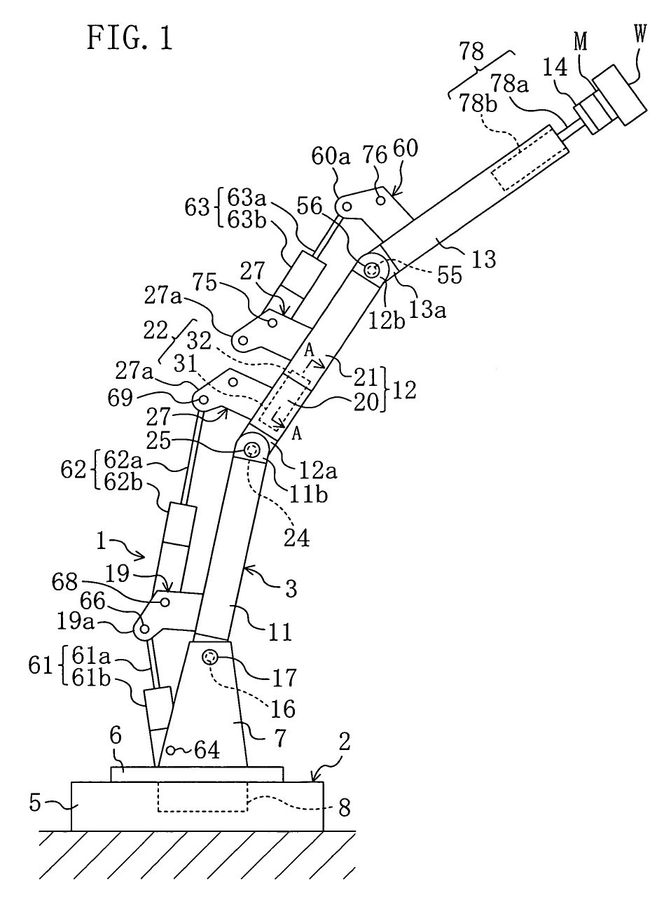

FIG. 1 shows an articulated industrial robot 1 according to an embodiment of the present invention. For example, the robot 1 is used for carrying a workpiece W (only shown in FIG. 1) in a vehicle assembly factory, a load handling field, etc.

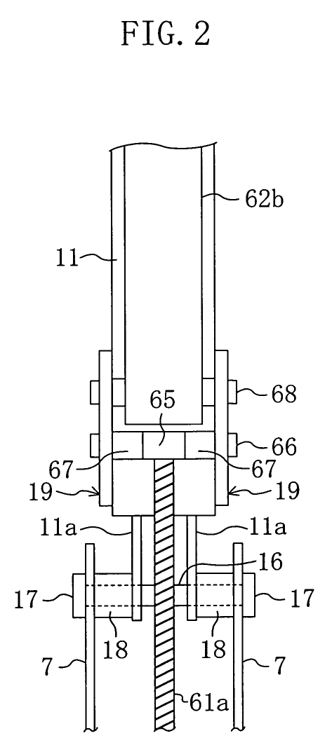

The robot 1 is formed by a base 2 fixed to the ground, a robot arm 3 attached to the base 2, and a robot controller 4 (shown in FIG. 5). The base 2 is formed by a principal part 5 which constitutes the lower part of the base 2, a rotating platform 6 provided on the upper surface of the principal part 5, and a pair of robot arm supporting elements 7 provided on the upper surface of the rotating platform 6. The rotating platform 6 supported on the principal part 5 by a pivotal shaft (not shown) which extends generally vertically. The rotating platform 6 is actuated by a platform actuator 8 to rotate around the pivotal shaft. The platform actuator 8 is formed by, for example, a motor, a speed reducer, etc. The robot arm supporting elements 7 each has a plate-like shape which extends upwardly from the upper surface of the rotating platform 6 as also shown in FIG. 2. The robot arm supporting elements 7 face each other and are fixed to the rotating platform 6 at the lower ends.

The robot arm 3 includes a base-side arm component 11, an intermediate arm component 12 and a tip-side arm component 13, which are sequentially provided from the base 2 to the tip side. The tip-side end of the tip-side arm component 13 is provided with a wrist 14 to which a material hand M is attached. The arm components 11 to 13 are each formed by a hollow rod which extends generally vertically.

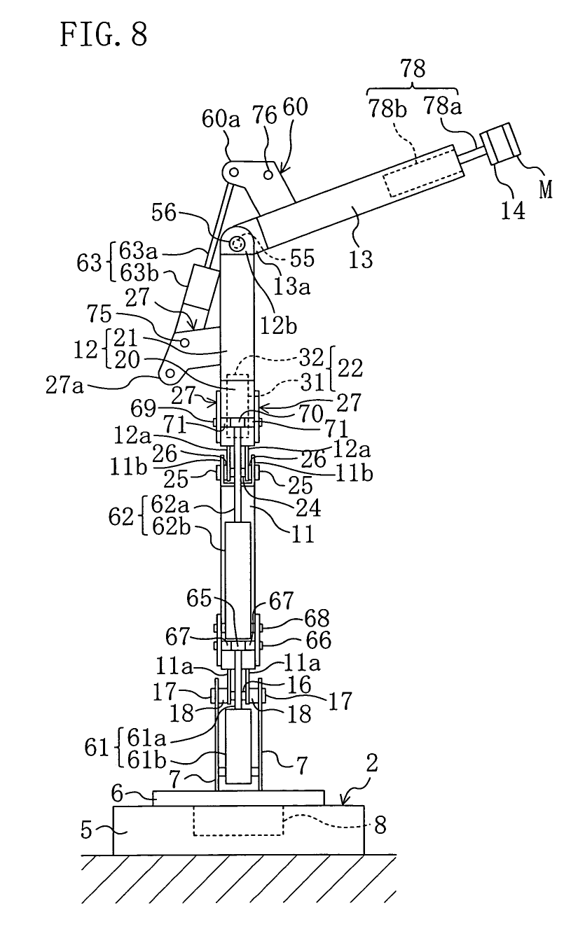

As shown in FIG. 2 and FIG. 8, an end of the base-side arm component 11 which is closer to the base 2 is provided with a pair of base-side connectors Ha protruding in the arm axis direction which is equal to the longitudinal direction of the arm. The base-side connectors 11a face each other with a certain interval therebetween. The base-side arm component 11 is located such that the base-side connectors 11a are between the robot arm supporting elements 7 and extends generally in parallel to the supporting elements 7. With this arrangement, the base-side connectors 11a are swingably connected to the robot arm supporting elements 7 at a position in the vicinity of the upper end of the supporting elements 7 by a first connection shaft 16 which extends generally horizontally. The first connection shaft 16 penetrates through the robot arm supporting elements 7 and the base-side connectors 11a. The both ends of the first connection shaft 16 are provided with detachably-attached stoppers 17 for preventing the first connection shaft 16 from dropping out. Also provided between the robot arm supporting elements 7 and the base-side connectors 11a are cylindrical spacers 18 through which the first connection shaft 16 is inserted.

The outer surface of an end of the base-side arm component 11 which is closer to the base 2 is provided with a pair of first plate members 19 protruding in a radial direction of the arm component 11 as also shown in FIG. 1. The first plate members 19 have the same shape and extend generally in parallel to each other with a certain interval therebetween as shown in FIG. 2. Referring to FIG. 1, the protrusion tip of each first plate member 19 has a bent nose 19a which is bent toward the base-side end of the base-side arm component 11. Referring to FIG. 8, the tip-side end of the base-side arm component 11 is provided with a pair of tip-side connectors 11b protruding in the arm axis direction. The tip-side connectors 11b face each other with a certain interval therebetween.

The intermediate arm component 12 is the second arm component of the claimed inventions. As also shown in FIG. 1, the intermediate arm component 12 is divided at an axially intermediate position into a base-side part 20 and a tip-side part 21 and has an arm rotator 22 (rotation means) for rotating the tip-side part 21 around the arm axis relative to the base-side part 20. As shown in FIG. 13, the base-side part 20 has a wall 20a at an end closer to the tip-side part 21, and the tip-side part 21 has a wall 21a at an end closer to the base-side part 20. The walls 20a and 21a are connected by connecting means (not shown) so as not to be separated from each other in the arm axis direction but rotatable around the arm axis.

The arm rotator 22 includes a drive shaft 30 which has a thread groove 30a in the external surface, a moving device 31 for axially moving the drive shaft 30, and a threaded member 32 meshed with the thread groove 30a of the drive shaft 30. The drive shaft 30 is formed by a trapezoidal screw shaft which has a trapezoidal thread groove extending between the axial ends. The outer surface of the drive shaft 30 has two axially-extending linear guide grooves 30b which are circumferentially separated by about 180° from each other. The moving device 31 is contained in the hollow region of the base-side part 20. The threaded member 32 is contained in the hollow region of the tip-side part 21.

The moving device 31 may be, for example, a device disclosed in Japanese Laid-Open Patent Publication No. 2003-343679. Specifically, the moving device 31 includes a motor 33, a speed reduction mechanism 34 and a nut 35, which are aligned in the axial direction of the drive shaft 30. The speed reduction mechanism 34 and the nut 35 are contained in a cylindrical casing 36 extending in the axial direction of the drive shaft 30. An output shaft 37 of the motor 33 has a cylindrical shape through which the drive shaft 30 is inserted and extends into the casing 36. The casing 36 is fixed to the base-side part 20.

The speed reduction mechanism 34 is formed by a planetary gear train. An internal gear 38 of the speed reduction mechanism 34 has a smaller diameter part 38a on the motor 33 side and a larger diameter part 38b on the nut 35 side. The smaller diameter part 38a and the larger diameter part 38b are an integral structure. The smaller diameter part 38a is fixed to the output shaft 37 by a bolt 40 so as to rotate integrally with the output shaft 37. The inner surface of the larger diameter part 38b has internal teeth 38c. The number of the internal teeth 38c is, for example, 61.

The inner surface of an axially intermediate part of the casing 36 has an annular attachment portion 41 protruding from the inner surface. A supporting shaft 43 is fixed to the attachment portion 41. The supporting shaft 43 rotatably supports a planet pinion 42 meshed with the internal teeth 38c of the internal gear 38. This structure has a plurality of planet pinions 42 and supporting shafts 43 along the periphery of the internal gear 38. The number of teeth of each planet pinion 42 is, for example, 16.

In the casing 36, a cylindrical output rotator 44 which functions as a sun gear is rotatably supported through two bearings 45. The output rotator 44 has a smaller diameter part 44a on the motor 33 side and a larger diameter part 44b on the other side. The smaller diameter part 44a and the larger diameter part 44b are an integral structure. The outer surface of the smaller diameter part 44a has teeth 44c meshed with the planet pinions 42. The number of teeth 44c of the output rotator 44 is, for example, 29.

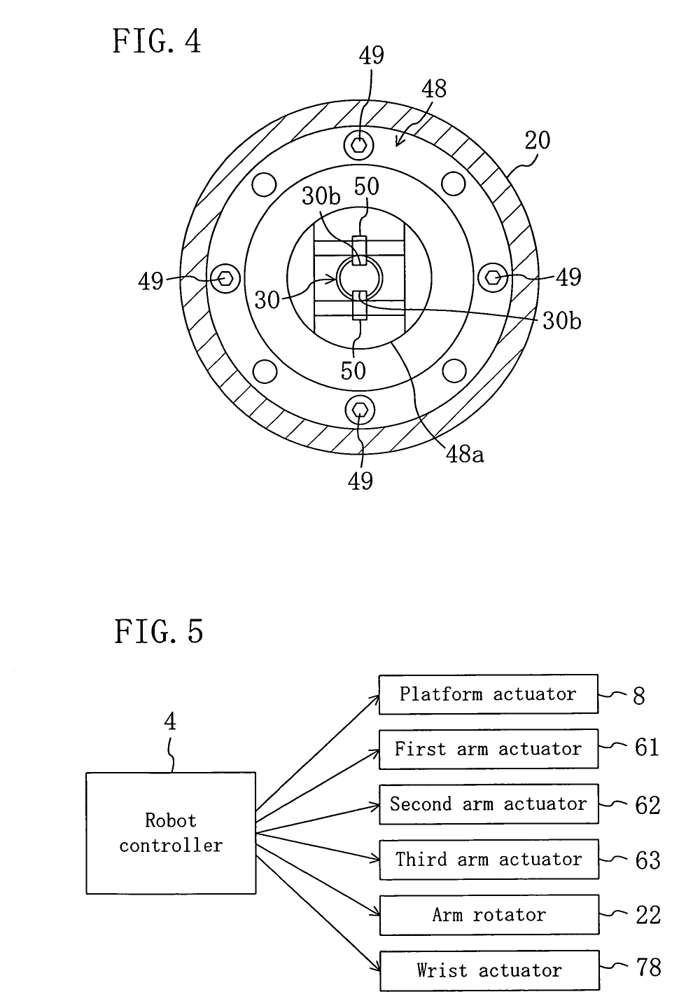

The bearings 45 are fixed onto the outer surface of the larger diameter part 44b of the output rotator 44. The nut 35 is fit in the inner surface of the larger diameter part 44b. The nut 35 is fixed to the output rotator 44 by a bolt 47. The inner surface of the nut 35 has a ridge (not shown) meshed with the thread groove 61c of the rod 61a . The casing 36 is provided with fixing means for restricting the rotation of the drive shaft 30. Specifically, a closing member 48 is fixed to the casing 36 by a bolt 49 to close an opening at the end surface of the casing 36. The closing member 48 is provided with an attachment portion 48a protruding outwardly of the casing 36. As also shown in FIG. 4, the attachment portion 48a is provided with two plate-like guiding members 50 as the fixing means. The guiding members 50 fit in the guide grooves 30b of the drive shaft 30.

The threaded member 32 has a hole 32a which has a shape to mesh with the drive shaft 30 and is fixed to the tip-side part 21.

As shown in FIG. 8, an end of the base-side part 20 which is closer to the base 2 is provided with base-side connectors 12a as is the base-side arm component 11. The intermediate arm component 12 is located such that the base-side connectors 12a are between the tip-side connectors 11b and extends generally in parallel to the tip-side connectors 11b. With this arrangement, the base-side connectors 12a are swingably connected to the base-side arm component 11 by a second connection shaft 24 which extends generally horizontally. The second connection shaft 24 has the same structure as that of the first connection shaft 16. The both ends of the second connection shaft 24 are provided with stoppers 25 as is the first connection shaft 16. Also provided between the tip-side connectors 11b of the base-side arm component 11 and the base-side connectors 12a of the intermediate arm component 12 are cylindrical spacers 26.

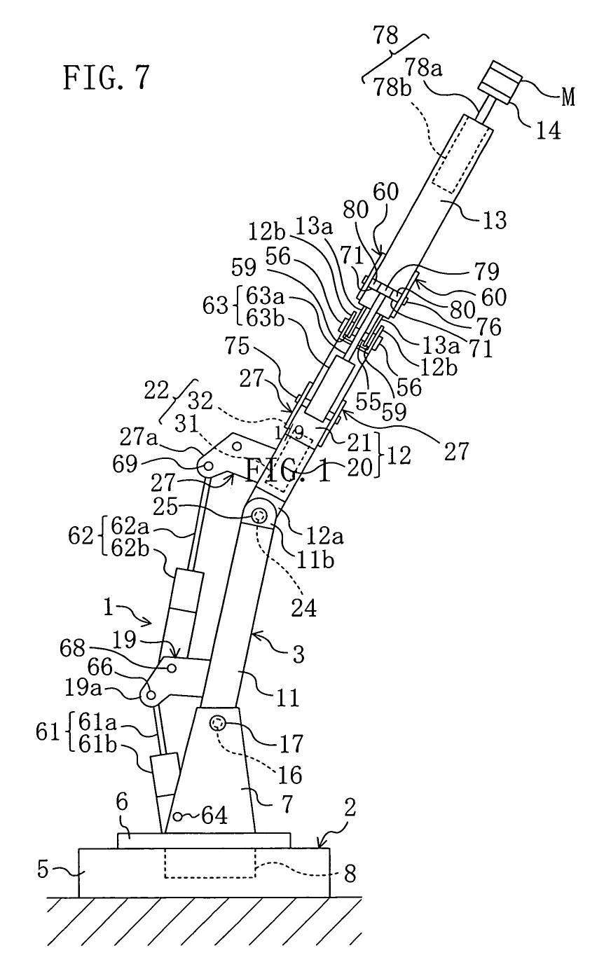

The tip-side end of the tip-side part 21 of the intermediate arm component 12 is provided with a pair of tip-side connectors 12b protruding in the arm axis direction as shown in FIG. 7. The tip-side connectors 12b face each other with a certain interval therebetween. The outer surface of the tip-side part 21 and the outer surface of the base-side part 20 are provided with second plate members 27 as also shown in FIG. 8. Each of the second plate members 27 has a bent nose 27a as does the first plate member 19.

The tip-side arm component 13 is the first arm component of the claimed inventions. Referring to FIG. 7, an end of the tip-side arm component 13 which is closer to the base 2 is provided with base-side connectors 13a as does the base-side arm component 11. The tip-side arm component 13 is located such that the base-side connectors 13a are generally in parallel to the tip-side connectors 12b of the intermediate arm component 12. With this arrangement, the base-side connectors 13a are swingably connected to the intermediate arm component 12 by a third connection shaft 55 which extends generally horizontally. The third connection shaft 55 has the same structure as that of the first connection shaft 16. The both ends of the third connection shaft 55 are provided with stoppers 56 as is the first connection shaft 16. Also provided between the tip-side connectors 12b of the intermediate arm component 12 and the base-side connectors 13a of the tip-side arm component 13 are cylindrical spacers 59. As also shown in FIG. 1, the outer surface of an end of the tip-side arm component 13 which is closer to the base 2 is provided with third plate members 60. Each of the third plate members 60 has a bent nose 60a as does the first plate member 19.

The base-side arm component 11 is actuated by a base-side arm actuator 61. The base-side arm actuator 61 includes a rod 61a and a principal part 61b for axially moving the rod 61a . The rod 61a and the principal part 61b have the same structures as the drive shaft 30 and the moving device 31, respectively. The outer surface of the principal part 61b is rotatably attached to the robot arm supporting elements 7 by a shaft 64 which extends generally in parallel to the first connection shaft 16. Referring to FIG. 2, a pole-like attachment portion 65 extending in a direction perpendicular to the rod 61a is fixed to an end of the rod 61a . The attachment portion 65 is located between the bent noses 19a of the first plate members 19 and rotatably attached to the bent noses 19a by a shaft 66. Provided between the attachment portion 65 and the bent noses 19a are spacers 67.

Referring to FIG. 1, the intermediate arm component 12 is actuated by an intermediate arm actuator 62. The intermediate arm actuator 62 has a rod 62a and a principal part 62b as does the base-side arm actuator 61. The principal part 62b is rotatably attached to the first plate members 19 by a shaft 68. As shown in FIG. 8, an attachment portion 70 provided at an end of the rod 62a is attached to the bent noses 27a of the second plate members 27 of the base-side part 20 by a shaft 69. It should be noted that reference numeral 71 denotes spacers.

The tip-side arm component 13 is actuated by a tip-side arm actuator 63. The tip-side arm actuator 63 has a rod 63a and a principal part 63b as does the base-side arm actuator 61. The principal part 63b is rotatably attached to the second plate members 27 of the tip-side part 21 by a shaft 75. As shown in FIG. 7, an attachment portion 79 provided at an end of the rod 63a is attached to the bent noses 60a of the third plate members 60 by a shaft 76. It should be noted that reference numeral 80 denotes spacers. The base-side arm actuator 61, the intermediate arm actuator 62 and the tip-side arm actuator 63 are the arm actuation means of the claimed inventions.

The tip-side end of the tip-side arm component 13 is provided with a wrist actuator (wrist actuation means) 78 for reciprocating the wrist 14 in the arm axis direction. The wrist actuator 78 includes a rod 78a and a principal part 78b for moving the rod 78a in the arm axis direction. The rod 78a and the principal part 78b have the same structures as the drive shaft 30 and the moving device 31, respectively.

Referring to FIG. 5, the platform actuator 8, the base-side arm actuator 61, the intermediate arm actuator 62, the tip-side arm actuator 63, the arm rotator 22 and the wrist actuator 78 are connected to the robot controller 4 and work independently of one another according to instructions from the robot controller 4.

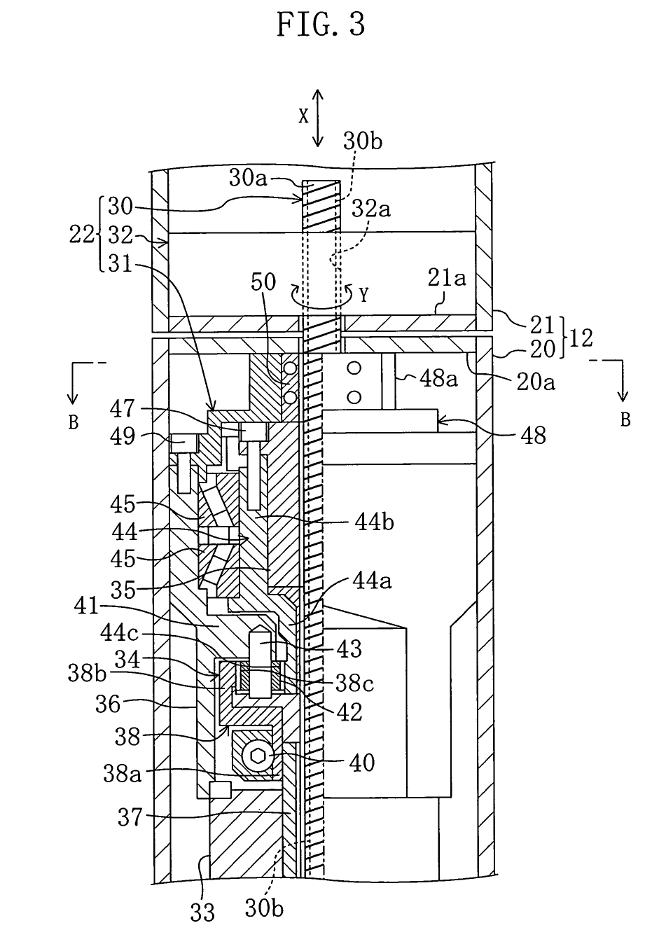

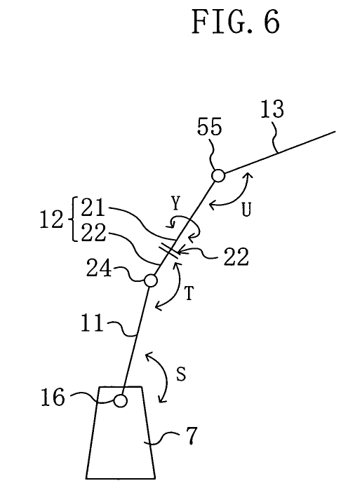

In the industrial robot 1 having the above-described structure, referring to FIG. 3, when the robot controller 4 starts the motor 33 of the arm rotator 22, the output shaft 37 rotates the internal gear 38. The rotation of the internal gear 38 rotates the planet pinions 42 so that the output rotator 44 and the nut 35 rotate in a direction opposite to the rotation direction of the internal gear 38. The rotation speed of the nut 35 is reduced by the speed reduction mechanism 34 to a predetermined speed, so that the torque of the nut 35 is increased. Meanwhile, the drive shaft 30 is prevented by the guiding members 50 from rotating and therefore axially travels along the guiding members 50 (in the direction shown by arrow X in FIG. 3). As the drive shaft 30 axially travels, the threaded member 32 meshed with the drive shaft 30 rotates around the drive shaft 30 (in the direction shown by arrow Y in FIG. 3). As a result, as schematically shown in FIG. 6, the tip-side part 21 of the intermediate arm component 12 rotates around the arm axis relative to the base-side part 20. The torque of the tip-side part 21 is obtained by the thrust of the drive shaft 30 which is produced by the moving device 31. The thrust of the drive shaft 30 is secured high because the speed reduction mechanism 34 provided between the motor 33 and the nut 35 increases the torque of the nut 35. Therefore, the torque of the tip-side part 21 is sufficiently obtained. The rotation direction of the tip-side part 21 can be changed by changing the rotation direction (forward or reverse) of the motor 33. The rotation angle of the tip-side part 21 can be set by changing the operating period of the motor 33.

When the robot controller 4 activates a motor (not shown) of the base-side arm actuator 61 in the forward or reverse direction, the rod 61a axially travels so that the length of a part of the rod 61a which is protruding out of the principal part 61b is changed. Accordingly, the base-side arm component 11 swings around the first connection shaft 16 as shown by arrow S in FIG. 6. Likewise, the intermediate arm component 12 and the tip-side arm component 13 are respectively actuated by the intermediate arm actuator 62 and the tip-side arm actuator 63 to swing around the second connection shaft 24 and the third connection shaft 55 as shown by arrow T and arrow U in FIG. 6. Further, when the platform actuator 8 is activated, the whole robot arm 3 rotates around the vertical axis.

When the tip-side part 21 of the intermediate arm component 12 in the state shown in FIG. 1 is rotated by the arm rotator 22 by about 90° to be in the state shown in FIG. 7 and FIG. 8, the tip-side arm component 13, the third connection shaft 55 and the tip-side arm actuator 63 rotate in the same direction by the same rotation angle. By rotating the tip-side arm component 13 together with the third connection shaft 55 and the tip-side arm actuator 63, the swing direction of the tip-side arm component 13 can be changed. As a result, the robot arm 3 gains improved flexibility in movement.

Workpiece W can be moved in the arm axis direction only by powering a motor (not shown) of the wrist actuator 78 without rotating the rotating platform 6 or swinging the arm components 11 or 12. The moving direction of the wrist 14 can be changed by changing the rotation direction (forward or reverse) of the motor (not shown) of the wrist actuator 78.

Now consider a case where the industrial robot 1 is installed in a vehicle assembly factory. In this case, although not shown, a steering wheel (workpiece W) on a pallet, or the like, is grasped by the wrist 14 and transferred to a driver's seat of a vehicle through a door opening in a body of the vehicle. Thereafter, a steering shaft of the vehicle body is inserted through an attachment hole of the steering wheel. For example, also in the process of installing a seat in the vehicle body, the seat (workpiece W) is grasped outside the vehicle compartment and then transferred into the vehicle compartment. Thereafter, attachment holes of the seat are aligned with attachment positions in the vehicle. Thus, in the process of transferring workpiece W grasped outside the vehicle compartment into the vehicle compartment, the transfer route is complicated because of pallets and vehicle parts distributed around the vehicle body. In this case, the arm rotator 22 is activated to change the swing direction of the tip-side arm component 13 as described above such that the arm components 11 to 13 and workpiece W are not interfered with by the pallets or vehicle parts. The industrial robot 1 can also be used for purposes other than attaching vehicle interior parts, for example, for attaching tires to the vehicle body.

In the process of installing a steering wheel, at the step of inserting a steering shaft in an attachment hole of the steering wheel, the robot arm 3 positions the steering wheel such that the attachment hole of the steering wheel is on an extension line of the steering shaft and that the arm axis line of the tip-side arm component 13 is generally coincident with the extension line of the steering shaft. Thereafter, the steering shaft can be inserted in the attachment hole of the steering wheel only by advancing the wrist 14 in the arm axis direction using the wrist actuator 78. This also applies to the step of inserting bolts in fastening holes of a tire wheel in a tire attaching process.

As described above, in the industrial robot 1 of this embodiment, the intermediate arm component 12 is divided into the base-side part 20 and the tip-side part 21, and the tip-side part 21 is rotated relative to the base-side part 20. Therefore, the swing direction of the tip-side arm component 13 can be changed, and the flexibility in movement of the robot arm 3 can be improved. Thus, the robot arm 3 can be moved such that arm components and workpiece W are not interfered with by the surrounding articles without removing articles around the place where workpiece W exists and the destination to which workpiece W is to be transferred or moving the robot arm itself to a different place. As a result, the robot arm 3 can smoothly transfer workpiece W.

Since the moving device 31 of the arm rotator 22 is contained in the base-side part 20 and the threaded member 32 is contained in the tip-side part 21, the robot arm 3 having the arm rotator 22 can be compactly constructed.

Since the moving device 31 of the arm rotator 22 includes the speed reduction mechanism 34, the tip-side part 21 can be rotated with sufficient force using a low-power, light-weight motor 33. Therefore, the robot arm 3 having the arm rotator 22 can be a light-weight robot arm.

Since the wrist 14 is moved by the wrist actuator 78 in the arm axis direction, workpiece W can be moved in the arm axis direction without rotating the rotating platform 6 or swinging the arm components 11 to 13. Thus, the flexibility in movement of the robot arm 3 can be further improved. When the wrist 14 is thus moved in the arm axis direction, it is not necessary to control the platform actuator 8 or the arm actuators 61 to 63. Therefore, the control of the robot arm 3 can be simplified.

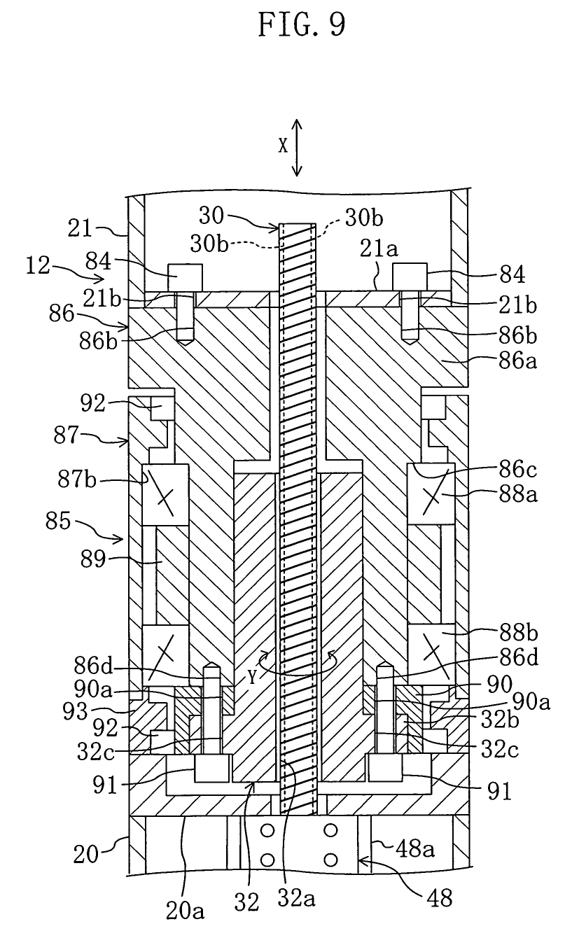

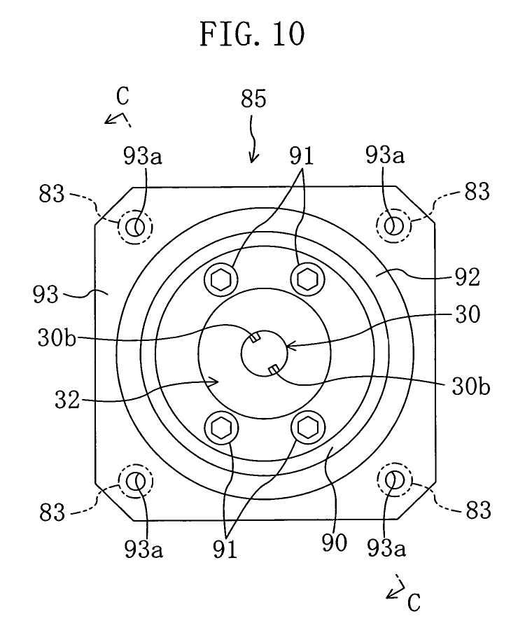

The base-side part 20 and the tip-side part 21 of the intermediate arm component 12 may be connected by a connecting element 85 shown in FIG. 9 and FIG. 10 so as not to be separated from each other in the arm axis direction but rotatable around the arm axis.

Referring to FIG. 9, the connecting element 85 includes a first cylindrical member 86 surrounding the drive shaft 30, a second cylindrical member 87 surrounding the outer surface of the first cylindrical member 86, and two bearings 88a and 88b provided between the outer surface of the first cylindrical member 86 and the inner surface of the second cylindrical member 87.

At an end of the first cylindrical member 86 which is adjacent to the tip-side part 21 is a flange 86a integrally formed by molding. The flange 86a has a plurality of axially-extending screw holes 86b opened in the surface closer to the tip-side part 21. The screw holes 86b are aligned along the circumference of the first cylindrical member 86 with certain intervals. The wall 21a of the tip-side part 21 has through holes 21b at positions corresponding to the screw holes 86b. Bolts 84 are inserted through the through holes 21b and meshingly inserted into the screw holes 86b, whereby the first cylindrical member 86 is fixedly fastened to the tip-side part 21.

An end surface of the first cylindrical member 86 which is closer to the base-side part 20 has a plurality of screw holes 86d which are aligned along the circumference of the first cylindrical member 86 with certain intervals. The outer surface of the first cylindrical member 86 has a step 86c in which the inner surface of the bearing 88a fits. The bearing 88b is separate from the bearing 88a and is closer to the base-side part 20 than the bearing 88a is. Between the bearings 88a and 88b is a cylindrical collar 89 for maintaining the interval between the bearings 88a and 88b. It should be herein noted that the bearings 88a and 88b are thrust bearings.

In an application where the connecting element 85 is used, the threaded member 32 has a cylindrical shape elongated in the axial direction of the drive shaft 30. An end of the threaded member 32 which is closer to the tip-side part 21 is inserted inside the first cylindrical member 86. At an end of the threaded member 32 which is closer to the base-side part 20 is a flange 32b integrally formed by molding. The flange 32b has a plurality of through holes 32c axially penetrating at positions corresponding to the screw holes 86d. When a side of the connecting element 85 is seen, the bearings 88a and 88b overlap the hole 32a of the threaded member 32.

Provided between the first cylindrical member 86 and the flange 32b of the threaded member 32 is an annular holding member 90 for holding the bearings 88a and 88b between the step 86c and the holding member 90. The holding member 90 has a plurality of through holes 90a axially penetrating at positions corresponding to the screw holes 86d. Bolts 91 are inserted through the through holes 32c of the flange 32b and the through holes 90a of the holding member 90 and meshingly inserted into the screw holes 86d, whereby the holding member 90 and the threaded member 32 are made integral with the first cylindrical member 86. With this arrangement, the inner surfaces of the bearings 88a and 88b are fixed to the first cylindrical member 86.

Provided between the inner surface of an end of the second cylindrical member 87 which is closer to the tip-side part 21 and the outer surface of the first cylindrical member 86 is an annular sealing member 92. The inner surface of the second cylindrical member 87 has a step 87b in which the outer surface of the bearing 88a fits. An end of the second cylindrical member 87 which is closer to the base-side part 20 is provided with an annular abutting member 93 which abuts on the outer periphery of the bearing 88b. The abutting member 93 fixed to the second cylindrical member 87 by a bolt (not shown) or the like. With this arrangement, the second cylindrical member 87 is integral with the outer periphery of the bearings 88a and 88b so that the second cylindrical member 87 does not axially travel relative to the first cylindrical member 86. Meanwhile, the second cylindrical member 87 and the abutting member 93 are rotatable around the first cylindrical member 86. Provided between the inner surface of the abutting member 93 and the outer surface of the holding member 90 is a sealing member 92.

The end surface of an end of the abutting member 93 which is closer to the base-side part 20 has a plurality of screw holes 93a which are aligned along the circumference of the abutting member 93 with certain intervals as illustrated in FIG. 10. The wall 20a of the base-side part 20 has through holes (not shown) at positions corresponding to the screw holes 93a. Bolts 83 (shown by imaginary lines in FIG. 10) are inserted through the through holes of the wall 20a and meshingly inserted into the screw holes 93a, whereby the second cylindrical member 87 and the abutting member 93 are made integral with the base-side part 20.

In the intermediate arm component 12 having the above-described connecting element 85, when the moving device 31 is actuated to move the drive shaft 30 in the direction indicated by arrow X, the first cylindrical member 86 integral with the threaded member 32 axially rotates relative to the second cylindrical member 87 which is integral with the base-side part 20 (indicated by arrow Y), so that the tip-side part 21 rotates relative to the base-side part 20.

Although in the above-described example of this embodiment the planetary gear train is provided as the speed reduction mechanism 34 to the moving device 31, the speed reduction mechanism 34 may be a gear mechanism different from the planetary gear train. Although in the above-described example of this embodiment the drive shaft 30 is a trapezoidal screw shaft formed such that the nut 35 meshes with the trapezoidal screw shaft, the drive shaft 30 may be a ball screw shaft formed such that the nut 35 meshes with the ball screw shaft.

Although in the above-described example of this embodiment the arm rotator 22 is provided to the intermediate arm component 12 for rotating the tip-side part 21, the arm component to which the arm rotator 22 is provided may be at least one of the arm components 11 and 12 which are positioned closer to the base 2 than the tip-side arm component 13 is. For example, it may be the base-side arm component 11. Alternatively, each of the base-side arm component 11 and the intermediate arm component 12 may have the arm rotator 22. With such a design, the flexibility in movement of the robot arm 3 is further improved.

The number of arm components of the robot arm 3 may be 2 or may be 4 or more. These arm components may have different lengths.

The arm actuators 61 to 63 may have, for example, a structure wherein the connection shafts 16, 24 and 55 are rotated by motors. Alternatively, the arm actuators 61 to 63 each may be a hydropneumatic cylinder device.

The industrial robot 1 may be used for, for example, removing a product molded by an injection molding machine, or the like, out of a mold die or attaching an insertion member to a mold die. Further, for example, it is also possible with the industrial robot 1 to transfer workpiece W from a pallet to another, to displace workpiece W from a pallet, and to place workpiece W on a pallet.

### INDUSTRIAL APPLICABILITY

As described above, an industrial robot of the present invention is suitable for, for example, carrying a workpiece in a vehicle assembly factory.

1. An articulated industrial robot, comprising: a robot arm including a plurality of arm components swingably connected to one another by connection shafts; and a base to which the robot arm is connected, wherein
the robot arm includes arm actuation means for swinging the arm components,
the arm components includes a first arm component at a tip side of the robot arm, the first arm component having a wrist at its tip-side end, and
the arm components includes a second arm component which is closer to the base than the first arm component is, the second arm component being divided at an axially intermediate position into a base-side part and a tip-side part, and the second arm component having rotation means for rotating the tip-side part around the arm axis relative to the base-side part
the rotation means includes a drive shaft extending in the arm axis direction and having a thread groove in its outer surface, a moving device for axially moving the drive shaft, and a threaded member meshed with the thread groove of the drive shaft, and
the moving device is fixed to one of the base-side part and the tip-side part, while the threaded member is fixed to the other.

2. The industrial robot of claim 1, wherein:
the base-side part and the tip-side part are hollow; and
the moving device is contained in one of the base-side part and the tip-side part, while the threaded member is contained in the other.

3. The industrial robot of claim 1 or 2, wherein the moving device includes a nut meshed with the thread groove of the drive shaft, a motor for rotating the nut around the drive shaft and a speed reduction mechanism for reducing a rotation speed of the output shaft of the motor to transmit a torque of the motor to the nut.

4. The industrial robot of any one of claims 1, wherein the first arm component includes wrist actuation means for reciprocating the wrist in the arm axis direction.

5. (canceled)
